(19) United States
(12) Patent Application Publication
(10) Pub. No.: US 2013/0324456 A1
(43) Pub. Date: Dec. 5, 2013

(54) SPRAY-DRIED DETERGTENT POWDER

(71) Applicant: The Procter & Gamble Company, Cincinnati, OH (US)

(72) Inventors: Hossam Hassan TANTAWY, Northumberland (GB); Adam PORTER, Newcastle upon Tyne (GB); Philip David DORGAN, Newcastle upon Tyne (GB)

(21) Appl. No.: 13/905,160

(22) Filed: May 30, 2013

(30) Foreign Application Priority Data
Jun. 1, 2012 (EP) 12170473.8
Mar. 5, 2013 (EP) 13157899.9

(51) Int. Cl. C11D 11/02

(52) U.S. Cl. CPC C11D 11/02
USPC 510/456; 264/13

(57) ABSTRACT

The present invention is a spray-dried powder comprising: at least 5 wt % of a spray-dried particle comprising at least 40 wt % anionic detersive surfactant, from 15 to 40 wt % carbonate and less than 20 wt % sulphate and having a bulk density of from 300 g/l to 450 g/l.

### FIELD OF THE INVENTION

The present invention is to a spray-dried particle and a method of making said particle.

### BACKGROUND OF THE INVENTION

Consumers associate suds generation during the wash with good cleaning. Upon addition to the wash liquor, granular detergent compositions dissolve and release suds generating ingredients, such as anionic surfactants, into the wash liquor. Often-times, in a hand wash context, to generate suds, consumers need to agitate the water in order to increase the rate of dissolution of the granular detergent composition, and hence generate suds. Consumers associate this slow dissolution time with poor cleaning performance.

Thus, there is a need in the art for a granular detergent composition that exhibits improved rate of suds generation and volume when added to the wash liquor. Consumers associate this ‘flash suds’ generation with fast and effective cleaning.

The Inventors surprisingly found that a granular detergent composition comprising at least 5 wt % of a spray-dried particle comprising at least 40 wt % anionic detersive surfactant, from 15 to 40 wt % carbonate, less than 20 wt % sulphate and having a bulk density of from 300 g/l to 450 g/l overcame this problem.

### SUMMARY OF THE INVENTION

A first aspect of the present invention is a granular detergent composition comprising at least 5 wt % of a spray-dried particle comprising at least 40 wt % anionic detersive surfactant, from 15 to 40 wt % carbonate, less than 20 wt % sulphate and having a bulk density of from 300 g/l to 450 g/l.

A second aspect of the present invention is a process for making the spray-dried powder according to the first aspect.

### DETAILED DESCRIPTION OF THE INVENTION

### Granular Detergent Composition

The granular detergent composition of the present invention comprises at least 5 wt % of a spray-dried particle comprising at least 40 wt % anionic detersive surfactant, from 15 to 40 wt % carbonate, less than 20 wt % sulphate and having a bulk density of from 300 g/l to 450 g/l.

The particle may comprise from 20 wt % to 80 wt % or from 50 wt % to 80 wt %, or even from 60 wt % to 80 wt % by weight of the granular detergent composition. Alternatively, the granular detergent composition may comprise from 20 wt % to 50 wt % of the particle. Alternatively, the particle may comprise at least 5 wt %, or even 7 wt % or even 12 wt % of the granular detergent composition. Alternatively, the particle may comprise between 5 wt % and 60 wt % or even between 7 wt % and 55 wt % or even between 10 wt % and 50 wt % or even between 12 wt % and 45 wt % of the granular detergent composition.

The granular detergent composition is suitable for any detergent application, for example: laundry, including automatic washing machine laundering and hand laundering, and even bleach and laundry additives; hard surface cleaning; dish washing, especially automatic dish washing; carpet cleaning and freshening. However, highly preferably, the spray-dried detergent powder is a spray-dried laundry detergent powder.

The laundry detergent composition can be a fully formulated detergent product, such as a fully formulated laundry detergent product, or it can be combined with other particles to form a fully formulated detergent product, such as a fully formulated laundry detergent product. The spray-dried particle may be combined with other particles such as: enzyme particles; perfume particles including agglomerates or extrudates of perfume microcapsules, and perfume encapsulates such as starch encapsulated perfume accord particles; surfactant particles, such as non-ionic detersive surfactant particles including agglomerates or extrudates, anionic detersive surfactant particles including agglomerates and extrudates, and cationic detersive surfactant particles including agglomerates and extrudates; polymer particles including soil release polymer particles, cellulosic polymer particles; buffer particles including carbonate salt and/or silicate salt particles, preferably a particle comprising carbonate salt and silicate salt such as a sodium carbonate and sodium silicate co-particle, and particles and sodium bicarbonate; other spray-dried particles; fluorescent whitening particles; aesthetic particles such as coloured noodles or needles or lamellae particles; bleaching particles such as percarbonate particles, especially coated percarbonate particles, including carbonate and/or sulphate coated percarbonate, silicate coated percarbonate, borosilicate coated percarbonate, sodium perborate coated percarbonate; bleach catalyst particles, such as transition metal catalyst bleach particles, and imine bleach boosting particles; preformed peracid particles; hueing dye particles; and any mixture thereof.

It may also be especially preferred for the granular detergent composition to comprise low levels, or even be essentially free, of builder. By essentially free of it is typically meant herein to mean: “comprises no deliberately added”. In a preferred embodiment, the granular detergent composition comprises no builder.

The granular detergent composition is typically flowable, typically having a cake strength of from 0 N to 20 N, preferably from 0 N to 15 N, more preferably from 0 N to 10 N, most preferably from 0 N to 5 N. The method to determine the cake strength is described in more detail elsewhere in the description.

The granular detergent composition typically comprises from 0 wt % to 7 wt %, preferably from 0.5 wt % to 5 wt %, and preferably from 1 wt % to 2 wt % water.

### Spray-Dried Particle

The spray-dried particle comprises at least 40 wt % anionic detersive surfactant, from 15 to 40 wt % carbonate, less than 20 wt % sulphate and has a bulk density of from 300 g/l to 450 g/l. The spray-dried particle may comprise from 0 to 5wt % polymer, or from 1 to 5 wt % polymer, or even 1.5 to 3 wt % polymer. Without wishing to be bound by theory, the presence of the polymer can act to decrease the ‘stickiness’ of the first particle. This has benefits on the flowability of the spray-dried powder. The polymer in the particle can be selected from a polycarboxylate homopolymer or a polycarboxylate copolymer, preferably the polymer is selected from polyacrylate homopolymer or acrylic acid/maleic acid copolymer. Suitable polymers are described in more detail below.

The particle may comprise at least 30 wt % or even at least 35 wt % or even at least 45 wt %, or even at least 50 wt % anionic detersive surfactant. Suitable anionic detersive surfactants are described in more detail below. The anionic detersive surfactant can be alkyl benzene sulphonic acid or salt thereof, alkyl ethoxylated sulphate, or a mixture thereof. The anionic detersive surfactant can be a mixture of alkyl benzene sulphonic acid or salt thereof and alkyl ethoxylated sulphate.

The particle may comprise less then 20 wt % or even less then 15 wt % or even less than 10 wt % or even less than 5 wt % sulphate. The sulphate is described in more detail below.

The particle may comprise from 0 to 20 wt %, or even from 1 to 20 wt % or even from 1 to 15 wt % or even from 1 to 10 wt % silicate.

The particle may comprise sodium hydroxide. The particle may comprise between 0.5 wt % and 5 wt %, or even between 1 wt % and 4 wt % sodium hydroxide.

The first particle may comprise HEDP, brighteners or a mixture thereof. Brighteners are described in more detail below.

The particle may have a mean particle size of between 350 and 500 μm, preferably 375-425 μm.

Without wishing to be bound by theory, it is believed that the specific high concentration of anionic detersive surfactant in the particle improves the rate of suds generation. This is because at this concentration, as the particle dissolves in the wash liquor, more suds generating anionic detersive surfactant is released into the wash liquor per unit time than a particle comprising a lower concentration of anionic surfactant.

Furthermore, a particle having the specific bulk density of the present invention tends to float in the wash liquor and so tends to dissolve more quickly. Unlike particles made by other means, such as agglomeration, spray-dried particles tend to have a lower bulk density. Heavier particles tend to sediment in the wash liquor and so not dissolve as quickly.

Thus, it is the combination of the low bulk density and high concentration of anionic surfactant that overcomes the above mentioned problem.

### Sulphate

The sulphate can be any suitable sulphate.

### Polymer

The polymer can be any suitable polymer. The anionic detersive surfactant can be alkyl benzene sulphonic acid or salt thereof, alkyl ethoxylated sulphate, or a mixture thereof. Preferably, the anionic detersive surfactant is a mixture of alkyl benzene sulphonic acid or salt thereof and alkyl ethoxylated sulphate.

Suitable polymers include carboxylate polymers, such as polyacrylates, and acrylate/maleate co-polymers and other functionalized polymers such as styrene acrylates. Preferably, the carboxylate polymer is an acrylate/maleate copolymer having an average molecular weight of about 2,000 to about 100,000 and a ratio of acrylate to maleate segments of from about 30:1 to about 1:1.

One suitable polymer is an amphiphilic graft polymer (AGP). Suitable AGPs are obtainable by grafting a polyalkylene oxide of number average molecular weight from about 2,000 to about 100,000 with vinyl acetate, which may be partially saponified, in a weight ratio of polyalkylene oxide to vinyl acetate of about 1:0.2 to about 1:10. The vinyl acetate may, for example, be saponified to an extent of up to 15 %. The polyalkylene oxide may contain units of ethylene oxide, propylene oxide and/or butylene oxide. Selected embodiments comprise ethylene oxide.

In some embodiments the polyalkylene oxide has a number average molecular weight of from about 4,000 to about 50,000, and the weight ratio of polyalkylene oxide to vinyl acetate is from about 1:0.5 to about 1:6. A material within this definition, based on polyethylene oxide of molecular weight 6,000 (equivalent to 136 ethylene oxide units), containing approximately 3 parts by weight of vinyl acetate units per 1 part by weight of polyethylene oxide, and having itself a molecular weight of about 24,000, is commercially available from BASF as Sokalan HP22.

Suitable AGPs may be present in the detergent composition at weight percentages of from about 0 to about 5%, preferably from about above 0% to about 4%, or from about 0.5% to about 2%. In some embodiments, the AGP is present at greater than about 1.5 wt %. The AGPs are found to provide excellent hydrophobic soil suspension even in the presence of cationic coacervating polymers.

Preferred AGPs are based on water-soluble polyalkylene oxides as a graft base and side chains formed by polymerization of a vinyl ester component. These polymers having an average of less than or equal to one graft site per 50 alkylene oxide units and mean molar masses (Mw) of from about 3000 to about 100,000.

Another suitable polymer is polyethylene oxide, preferably substituted or un-substituted.

Another suitable polymer is cellulosic polymer, preferably selected from alkyl cellulose, alkyl alkoxyalkyl cellulose, carboxylalkyl cellulose, alkyl carboxyalkyl, more preferably selected from carboxymethyl cellulose (CMC) including blocky CMC, methyl cellulose, methyl hydroxyethyl cellulose, methyl carboxymethyl cellulose, and mixtures thereof.

Other suitable polymers are soil release polymers. Suitable polymers include polyester soil release polymers. Other suitable polymers include terephthalate polymers, polyurethanes, and mixtures thereof. The soil release polymers, such as terephthalate and polyurethane polymers can be hydrophobically modified, for example to give additional benefits such as sudsing.

Other suitable polymers include polyamines, preferably polyethylene imine polymers, preferably having ethylene oxide and/or propylene oxide functionalized blocks

Other suitable polymers include synthetic amino containing amphoteric/and/or zwitterionic polymers, such as those derived from hexamethylene diamine.

Another suitable polymer is a polymer that can be co-micellized by surfactants, such as the AGP described in more detail above.

Other suitable polymers include silicone, including amino-functionalised silicone. Suitable polymers can include clay and soil removal/anti-redeposition agents being co-polymers comprising:
(i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

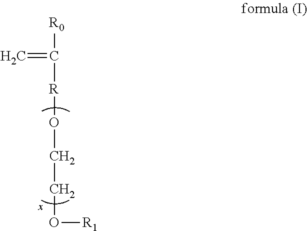

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

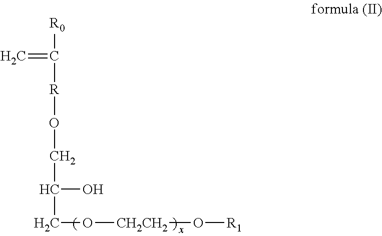

in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

Other suitable polymers include polysaccharide polymers such as celluloses, starches, lignins, hemicellulose, and mixtures thereof.

Other suitable polymers include cationic polymers, such as deposition aid polymers, such as cationically modified cellulose such as cationic hydroxy ethylene cellulose, cationic guar gum, cationic starch, cationic acrylamides and mixtures thereof.

Mixtures of any of the above described polymers can be used herein.

### Anionic Detersive Surfactant

Suitable anionic detersive surfactants include sulphate and sulphonate detersive surfactants.

Preferred sulphonate detersive surfactants include alkyl benzene sulphonate, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable.

Preferred sulphate detersive surfactants include alkyl sulphate, preferably C₈₋₁₈ alkyl sulphate, or predominantly C₁₂ alkyl sulphate.

Another preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 7, more preferably from 0.5 to 5 and most preferably from 0.5 to 3.

The alkyl sulphate, alkyl alkoxylated sulphate and alkyl benzene sulphonates may be linear or branched, substituted or un-substituted.

### Brightener

Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The granular detergent composition preferably comprises C.I. fluorescent brightener 260 in alpha-crystalline form having the following structure:

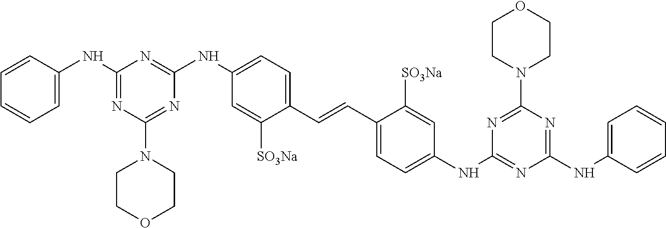

The C.I. fluorescent brightener 260 is preferably predominantly in alpha-crystalline form. Predominantly in alpha-crystalline form means that preferably at least 50 wt %, or at least 75 wt %, or even at least 90 wt %, or at least 99 wt %, or even substantially all, of the C.I. fluorescent brightener 260 is in alpha-crystalline form.

The brightener is typically in micronized particulate form, having a weight average primary particle size of from 3 to 30 micrometers, preferably from 3 micrometers to 20 micrometers, and most preferably from 3 to 10 micrometers.

The detergent composition may comprises C.I. fluorescent brightener 260 in beta-crystalline form, and preferably the weight ratio of: (i) C.I. fluorescent brightener 260 in alpha-crystalline form, to (ii) C.I. fluorescent brightener 260 in beta-crystalline form is at least 0.1, preferably at least 0.6.

BE680847 relates to a process for making C.I fluorescent brightener 260 in alpha-crystalline form.

### Zeolite Builder

Suitable zeolite builder includes include zeolite A, zeolite P and zeolite MAP. Especially suitable is zeolite 4A.

### Phosphate Builder

A typical phosphate builder is sodium tri-polyphosphate.

### Silicate Salt

A suitable silicate salt is sodium silicate, preferably 1.6 R and/or 2.0 R sodium silicate.

### Other Detergent Ingredients

The granular detergent composition typically comprises other detergent ingredients. Suitable detergent ingredients include: transition metal catalysts; imine bleach boosters; enzymes such as amylases, carbohydrases, cellulases, laccases, lipases, bleaching enzymes such as oxidases and peroxidases, proteases, pectate lyases and mannanases; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; fillers such as sodium sulphate, although it may be preferred for the composition to be substantially free of fillers; carbonate salt including sodium carbonate and/or sodium bicarbonate; silicate salt such as sodium silicate, including 1.6 R and 2.0 R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

### Method of Laundering Fabric

The method of laundering fabric typically comprises the step of contacting the composition to water to form a wash liquor, and laundering fabric in said wash liquor, wherein typically the wash liquor has a temperature of above 0° C. to 95° C., or to 60° C., or to 40° C., or to 30° C., or to 20° C., or to 10° C., or even to 8° C. The fabric may be contacted to the water prior to, or after, or simultaneous with, contacting the laundry detergent composition with water. The composition can be used in pre-treatment applications.

Typically, the wash liquor is formed by contacting the laundry detergent to water in such an amount so that the concentration of laundry detergent composition in the wash liquor is from above 0 g/l to 10 g/l, or from 1 g/l, to 5 g/l or to 4.5 g/l, or to 4.0 g/l, or to 3.5 g/l, or to 3.0 g/l, or to 2.5 g/l, or even to 2.0 g/l, or even to 1.5 g/l.

The method of laundering fabric may be carried out in a top-loading or front-loading automatic washing machine, or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 75 litres or less of water, or 40 litres or less, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water.

Typically from 0.01 kg to 2 kg of fabric per litre of wash liquor is dosed into said wash liquor. Typically from 0.01 kg, or from 0.05 kg, or from 0.07 kg, or from 0.10 kg, or from 0.15 kg, or from 0.20 kg, or from 0.25 kg fabric per litre of wash liquor is dosed into said wash liquor.

Optionally, from 5 g, or even from 10 g or even from 20 g, or even from 30 g to 40 g, or even to 50 g, or even to 60 g, or even to 80 g, or even to 100 g or even to 150 g or even to 200 g or even to 300 g of the composition is contacted to water to form the wash liquor.

In one embodiment, the granular laundry detergent composition is added to a small quantity of water to make a paste. The ratio of granular laundry detergent composition to water is in the range of 40:60 to 80:20. Typically, from 40 g to 250 g of the paste is made. The paste can be added directly to a fabric, or to a wash liquor or a combination thereof. Typically, at least 1 g of the paste is added per fabric.

### Method for Measuring Cake Strength

A smooth plastic cylinder of internal diameter 6.35 cm and length 15.9 cm is supported on a suitable base plate. A 0.65 cm hole is drilled through the cylinder with the centre of the hole being 9.2 cm from the end opposite the base plate.

A metal pin is inserted through the hole and a smooth plastic sleeve of internal diameter 6.35 cm and length 15.25 cm is placed around the inner cylinder such that the sleeve can move freely up and down the cylinder and comes to rest on the metal pin. The space inside the sleeve is then filled (without tapping or excessive vibration) with the spray-dried powder such that the spray-dried powder is level with the top of the sleeve. A lid is placed on top of the sleeve and a 5 kg weight placed on the lid. The pin is then pulled out and the spray-dried powder is allowed to compact for 2 minutes. After 2 minutes the weight is removed, the sleeve is lowered to expose the powder cake with the lid remaining on top of the powder.

A metal probe is then lowered at 54 cm/min such that it contacts the centre of the lid and breaks the cake. The maximum force required to break the cake is recorded and is the result of the test. A cake strength of 0 N refers to the situation where no cake is formed.

### Spray-Drying Process

The process for making the spray-dried particle of the present invention comprises the steps of;
a) preparing an aqueous slurry comprising anionic surfactant, carbonate, water and if present, silicate, polymer, and sulphate;
b) spraying the aqueous slurry through a spray nozzle into a spray-drying tower; and
c) spray-drying the mixture to form the spray-dried particle.

Step (a): the aqueous slurry can be formed by mixing in any suitable vessel, such as a mixer, in the standard manner. Suitable mixers include vertical mixers, slurry mixers, tank agitators, crutcher mixers and the like.

Step (b): the aqueous slurry is transferred from the mixer, preferably through at least one pump, to a spray nozzle. Typically, the aqueous slurry is transferred in a pipe. The aqueous slurry is typically transferred though an intermediate storage vessel such as a drop tank, for example when the process is semi-continuous. Alternatively, the process can be a continuous process, in which case no intermediate storage vessel is required. The aqueous slurry is transferred through at least one pump, preferably at least two, or even at least three or more pumps, although one or two, preferably two pumps may be preferred. Typically, when two or more pumps are used, the first pump is a low pressure pump, such as a pump that is capable of generating a pressure of from 3×10⁵ to 1×10⁶ Pa, and the second pump is a high pressure pump, such as a pump that is capable of generating a pressure of from 2×10⁶ to 1×10⁷ Pa. Optionally, the aqueous slurry is transferred through a disintegrator, such as disintegrators supplied by Hosakawa Micron. The disintegrator can be positioned before the pump, or after the pump. If two or more pumps are present, then the disintegrator can also be positioned between the pumps. Typically, the pumps, disintegrators, intermediate storage vessels, if present, are all in series configuration. However, some equipment may be in a parallel configuration. A suitable spray nozzle is a Spray Systems T4 Nozzle.

The aqueous slurry may be made by firstly mixing the carbonate and water and if present the silicate, polymer, sodium hydroxide and sulphate. This aqueous slurry is then pumped along a pipe to the spray nozzle and the anionic detersive surfactant is injected into the pipe before the first aqueous slurry is sprayed from the spray nozzle. Preferably, the aqueous slurry is passed through a first pump prior to addition of the anionic detersive surfactant and then passed through a second pump before passing to the spray nozzle. A gas, preferably air, may be pumped into the anionic detersive surfactant, preferably at a pressure of between 0.1 MPa and 2 MPa, prior to it being contacted with the aqueous slurry. Alternatively, a gas can be injected directly into the slurry at any point before the spray nozzle, preferably between the first and second pumps. By ‘air’ we herein mean atmospheric air.

Preferably, during step (b) the pipe carrying the aqueous slurry is at a pressure between 3×10⁵ and 1×10⁶ Pa.

In step (b), it may be preferred that additionally sodium chloride is contacted to the aqueous slurry after the mixer and before the spray nozzle.

The aqueous slurry is sprayed through the spray nozzle into a spray-drying tower. Preferably, the aqueous slurry is at a temperature of from 60° C. to 130° C. when it is sprayed through the spray nozzle into a spray-drying tower. Suitable spray-drying towers are co-current or counter-current spray-drying towers. The slurry is typically sprayed at a pressure of from 3×10⁶ Pa to 1×10⁷ Pa.

Step (c): the slurry is spray-dried to form a spray-dried particle. Preferably, the exhaust air temperature is in the range of from 60° C. to 100° C.

Preferably when added to the aqueous slurry, the sulphate has a volume average particle size of from 10 micrometers to 50 micrometers, preferably from 20 micrometers, or from 30 micrometers, and preferably to 45 micrometers, or even to 42 micrometers. The volume average particle size of the sulphate can be determined by any conventional means, such as light scattering, for example using a sympatec particle size analyser. The particle size of the inorganic salt can be controlled (i.e. reduced) by any suitable means, such as dry grinding (e.g. using pin mills) or wet grinding (e.g. using colloid mill). Without wishing to be bound by theory, smaller particle size sulphate dissolves more efficiently into the aqueous slurry. It is believed this is due to the larger surface area of the sulphate particles. This improved efficiency of dissolution has the benefit that less sulphate sediments out of the slurry during the manufacturing process. Sedimentation can cause blockages in the apparatus and so negatively affect production.

### EXAMPLES

A comparison was made between particles made according to the present invention and particles outside of the present invention for suds volume generation over time following addition to a wash liquor.

Particle 1 was prepared via spray drying in accordance with the process of the present invention. The particle comprised 40 wt % anionic detersive surfactant, 35 wt % carbonate, 0.85 wt % sulphate and had a bulk density of 300 g/L.

Particle 2 was prepared via agglomeration. It comprised 40 wt % anionic detersive surfactant, 12 wt % carbonate, 0 wt % sulphate and had a bulk density of 1000 g/L.

Particle 3 was prepared via spray drying. It comprised 24 wt % anionic detersive surfactant, 30 wt % carbonate, 22.7 wt % sulphate and had a bulk density of 400 g/L.

Suds volume over time was measured using a tumbling tube. The device comprises acrylic cylinders having rubber stoppers. Into the cylinders, 600 ml of deionised water is added and 1.38 g of the particle, in order to make a 2300 ppm solution at 20.5° C. The samples are then spun for 5 seconds and the height of the suds measured. They are then spun for a further 10 seconds and the height measured again. Results can be seen in Table 1.

TABLE 1

| Suds height in cm | 5 second spin | 10 second spin |
|---|---|---|
| Particle 1 | 4 | 6.75 |
| Particle 2 | 2.75 | 4.75 |
| Particle 3 | 3 | 5.25 |

As can be seen from Table 1, particle 1 generated a greater suds volume at a faster rate as compared to particles outside of the present invention. Thus, particle 1 exhibited ‘flash suds’ generation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A granular detergent composition comprising at least about 5 wt % of a spray-dried particle comprising at least about 40 wt % anionic detersive surfactant, from about 15 to about 40 wt % carbonate, less than about 20 wt % sulphate and having a bulk density of from about 300 g/l to about 450 g/l.

2. The granular detergent composition according to claim 1, wherein the particle has a mean particle size of between about 350 μm and about 500 μm,

3. The granular detergent composition according to claim 2, wherein the particle has a mean particle size of between about 375 μm and about 425 μm.

4. The granular detergent composition according to claim 1, wherein the particle comprises from about 0 to about 5 wt % polymer.

5. The granular detergent composition according to claim 4, wherein the polymer is selected from a polycarboxylate homopolymer or a polycarboxylate copolymer or a mixture thereof.

6. The granular detergent composition according to claim 5, wherein the polymer is selected from polyacrylate homopolymer or acrylic acid/maleic acid copolymer or a mixture thereof.

7. The granular detergent composition according to claim 4, wherein the polymer is selected from the group consisting of:
(I) co-polymers comprising:
(i) from about 50 to less than about 98 wt % structural units derived from one or more monomers comprising carboxyl groups;
(ii) from about 1 to less than about 49 wt % structural units derived from one or more monomers comprising sulfonate moieties; and
(iii) from about 1 to about 49 wt % structural units derived from one or more types of monomers selected from ether bond-containing monomers represented by formulas (I) and (II): 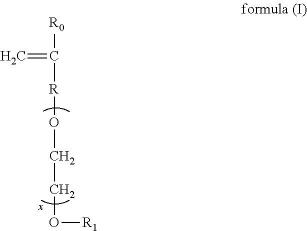
wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group; 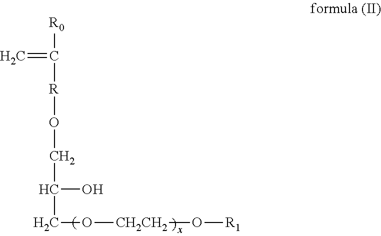
in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group;
(II) any combination thereof.

8. The granular detergent composition according to claim 1, wherein the anionic detersive surfactant is linear alkylbenzene sulfonate, alkyl ethoxylated sulphate or a mixture thereof.

9. The granular detergent composition according to claim 1, wherein the particle comprises sodium hydroxide.

10. The granular detergent composition according to claim 1, wherein the particle comprises HEDP, brighteners or a mixture thereof.

11. A process for making a spray-dried particle according to claim 1 comprising the steps of;
a) preparing an aqueous slurry comprising anionic surfactant, carbonate and water, and if present silicate, polymer and sulphate;
b) spraying the aqueous slurry through a spray nozzle into a spray-drying tower; and
c) spray-drying the mixture to form the spray-dried particle.

12. The process according to claim 11, wherein carbonate and water and if present silicate, polymer, and sulphate are mixed together and then pumped along a pipe to the spray nozzle, and wherein the anionic detersive surfactant is injected into the pipe before the aqueous slurry is sprayed from the first spray nozzle.

13. The process according to claim 11, wherein the sulphate added to the aqueous slurry has a volume average particle size of from about 10 micrometers to about 50 micrometers.

14. The process according to claim 13, wherein the sulphate added to the aqueous slurry has a volume average particle size of from about 20 micrometers to about 45 micrometers.

15. The process according to claim 14, wherein the sulphate added to the aqueous slurry has a volume average particle size of from about 30 micrometers to about 42 micrometers.
